(19) United States
(12) Patent Application Publication
(10) Pub. No.: US 2007/0236469 A1
(43) Pub. Date: Oct. 11, 2007

(54) Fluid level sensing utilizing a mutual capacitance touchpad device

(76) Inventors: Richard Woolley, Orem, UT (US); Brian Taylor, Irwin, ID (US)

Correspondence Address: MORRISS OBRYANT COMPAGNI, P.C., 734 EAST 200 SOUTH, SALT LAKE CITY, UT, 84102, US

(21) Appl. No.: 11/394,385

(22) Filed: Mar. 30, 2006

(51) Int. Cl. G06F 3/041

(52) U.S. Cl. 345/173

(57) ABSTRACT

A capacitance-sensitive sensor array and associated touchpad sensor circuitry, the sensor array comprised of a flexible substrate having a plurality of printed conductor elements disposed thereon to form the sensor array, the printed conductor elements being coupled to touchpad sensor circuitry that includes data processing capabilities, wherein the sensor array is disposed along an outside surface of a container, wherein the sensor array is capable of conforming to a curved or irregular outside surface of the container, wherein the sensor array detects at least one characteristic of at least one fluid disposed within the container, and wherein the touchpad sensor circuitry processes data received from the sensor array to provide information regarding the at least one fluid.

### CROSS-REFERENCE TO RELATED APPLICATIONS

The present invention incorporates by reference all of the subject matter of issued U.S. Pat. No. 6,680,731 B2.

### BACKGROUND OF THE INVENTION

1. Field of the Invention

This invention relates generally to fluid level sensing devices. More specifically, the invention relates to the application of capacitive sensor-based touchpad technology in a fluid level sensor, wherein the touchpad is disposed on an exterior container wall, is able to conform to contours of the container wall, and provide precise fluid level sensing along its length. The invention also relates to the sensing of solids and gases using the same touchpad technology.

2. Description of Related Art

The need for accurate fluid level sensing is well known to those skilled in the art. Accurate determination of fluid levels has both industrial and environmental applications. Industrial applications include the measuring of petrochemicals at industrial and commercial sites. It is often the case that the containers for these materials are difficult to reach. Environmental applications include the monitoring of water levels in reservoirs, rivers, and even streams. Because of the diverse types of fluids (including gases and solids capable of flowing) that need to be monitored, the locations of containers, and the environments in which the fluids must be measured, the state of the art of the sensors used is quite varied.

Along with the variety of sensors, another common factor is the cost. Many such sensors used at industrial sites can cost nearly $100,000 per device.

The different types of technology used in the sensors include capacitance-sensitive devices that require multiple sensing devices, probes that utilize RF circuitry, complex arrays of sensors, moving probes, and sensors that can only be external to a container. There has been extensive development of fluid level sensors that can be used in various environments and with different fluids. Generally the sensors suffer from various drawbacks, not the least of which is that they can be complicated, expensive, unreliable, and applicable to only one type of fluid, or applicable in either a wet or a dry condition, but not both. There are also various other drawbacks specific to each type of technology being used.

Accordingly, it would be an advantage over the state of the art of current fluid level sensors to provide a new fluid level sensing device that is versatile, inexpensive, can be provided in mass quantities, is reliable, will work with sloshing fluids, can be used in harsh environments, utilizes well-known technology that is being applied to a new purpose, and may be capable of providing more information about a fluid or fluids than just fluid level determination.

In order to understand how a touchpad can be use as a fluid level and fluid characteristic determining device, it is useful to briefly review operation of a touchpad.

The CIRQUE™ Corporation touchpad is a mutual capacitance-sensing device and an example is illustrated in FIG. 1. In this touchpad, a grid of row and column electrodes is used to define the touch-sensitive area of the touchpad. Typically, the touchpad is a rectangular grid of approximately 16 by 12 electrodes, or 8 by 6 electrodes when there are space constraints. Interlaced with these row and column electrodes is a single sense electrode. All position measurements are made through the sense electrode.

In more detail, FIG. 1 shows a capacitance sensitive touchpad 10 as taught by Cirque® Corporation includes a grid of row (12) and column (14) (or X and Y) electrodes in a touchpad electrode grid. All measurements of touchpad parameters are taken from a single sense electrode 16 also disposed on the touchpad electrode grid, and not from the X or Y electrodes 12, 14. No fixed reference point is used for measurements. Touchpad sensor control circuitry 20 generates signals from P,N generators 22, 24 that are sent directly to the X and Y electrodes 12, 14 in various patterns. Accordingly, there is a one-to-one correspondence between the number of electrodes on the touchpad electrode grid, and the number of drive pins on the touchpad sensor control circuitry 20.

The touchpad 10 does not depend upon an absolute capacitive measurement to determine the location of a finger (or other capacitive object) on the touchpad surface. The touchpad 10 measures an imbalance in electrical charge to the sense line 16. When no pointing object is on the touchpad 10, the touchpad sensor control circuitry 20 is in a balanced state, and there is no signal on the sense line 16. There may or may not be a capacitive charge on the electrodes 12, 14. In the methodology of Cirque® Corporation, that is irrelevant. When a pointing device creates imbalance because of capacitive coupling, a change in capacitance occurs on the plurality of electrodes 12, 14 that comprise the touchpad electrode grid. What is measured is the change in capacitance, and not the absolute capacitance value on the electrodes 12, 14. The touchpad 10 determines the change in capacitance by measuring the amount of charge that must be injected onto the sense line 16 to reestablish or regain balance on the sense line.

The touchpad 10 must make two complete measurement cycles for the X electrodes 12 and for the Y electrodes 14 (four complete measurements) in order to determine the position of a pointing object such as a finger. The steps are as follows for both the X 12 and the Y 14 electrodes:

First, a group of electrodes (say a select group of the X electrodes 12) are driven with a first signal from P, N generator 22 and a first measurement using mutual capacitance measurement device 26 is taken to determine the location of the largest signal. However, it is not possible from this one measurement to know whether the finger is on one side or the other of the closest electrode to the largest signal.

Next, shifting by one electrode to one side of the closest electrode, the group of electrodes is again driven with a signal. In other words, the electrode immediately to the one side of the group is added, while the electrode on the opposite side of the original group is no longer driven.

Third, the new group of electrodes is driven and a second measurement is taken.

Finally, using an equation that compares the magnitude of the two signals measured, the location of the finger is determined.

Accordingly, the touchpad 10 measures a change in capacitance in order to determine the location of a finger. All of this hardware and the methodology described above assume that the touchpad sensor control circuitry 20 is directly driving the electrodes 12, 14 of the touchpad 10. Thus, for a typical 12×16 electrode grid touchpad, there are a total of 28 pins (12+16=28) available from the touchpad sensor control circuitry 20 that are used to drive the electrodes 12, 14 of the electrode grid.

The sensitivity or resolution of the CIRQUE® Corporation touchpad is much higher than the 16 by 12 grid of row and column electrodes implies. The resolution is typically on the order of 960 counts per inch, or greater. The exact resolution is determined by the sensitivity of the components, the spacing between the electrodes on the same rows and columns, and other factors that are not material to the present invention.

Although the CIRQUE® touchpad described above uses a grid of X and Y electrodes and a separate and single sense electrode, the sense electrode can also be the X or Y electrodes by using multiplexing. Either design will enable the present invention to function.

### BRIEF SUMMARY OF THE INVENTION

It is an object of the present invention to provide a fluid level sensing system that utilizes capacitance-sensitive touchpad technology.

It is another object to provide the fluid level sensing system that is capable of determining the presence or the absence of a fluid in a container.

It is another object to provide a fluid level sensing system that is capable of determining composition or characteristics of fluid materials stored in a container.

It is another object to provide the fluid level sensing system that is capable of determining the level of the fluid in the container over the length of a capacitance-sensitive sensing device.

It is another object to provide the fluid level sensing system that is easily able to conform to a surface of a container.

It is another object to provide the fluid level sensing system that is able to operate through a non-metallic container.

It is another object to provide the fluid level sensing system that utilizes mutual capacitance sensing technology.

It is another object to detect different layers of fluids within a container.

In a preferred embodiment, the present invention is a capacitance-sensitive sensor array and associated touchpad sensor circuitry, the sensor array comprised of a flexible substrate having a plurality of printed conductor elements disposed thereon to form the sensor array, the printed conductor elements being coupled to touchpad sensor circuitry that includes data processing capabilities, wherein the sensor array is disposed along an outside surface of a container, wherein the sensor array is capable of conforming to a curved or irregular outside surface of the container, wherein the sensor array detects at least one characteristic of at least one fluid disposed within the container, and wherein the touchpad sensor circuitry processes data received from the sensor array to provide information regarding the at least one fluid.

These and other objects, features, advantages and alternative aspects of the present invention will become apparent to those skilled in the art from a consideration of the following detailed description taken in combination with the accompanying drawings.

### DESCRIPTION OF THE SEVERAL VIEWS OF THE DRAWINGS

FIG. 1 is a block diagram of the components of a capacitance-sensitive touchpad as made by CIRQUE® Corporation.

FIG. 2 is perspective view of a sensor array disposed on the outside of a container, and used to determine at least one characteristic of a fluid within.

FIG. 3 is perspective view of a sensor array disposed inside a container, and used to determine at least one characteristic of a fluid within.

FIG. 4 is a display showing an output that is illustrative of signal strength of various fluids being detected by a capacitance-sensitive sensor array of the present invention.

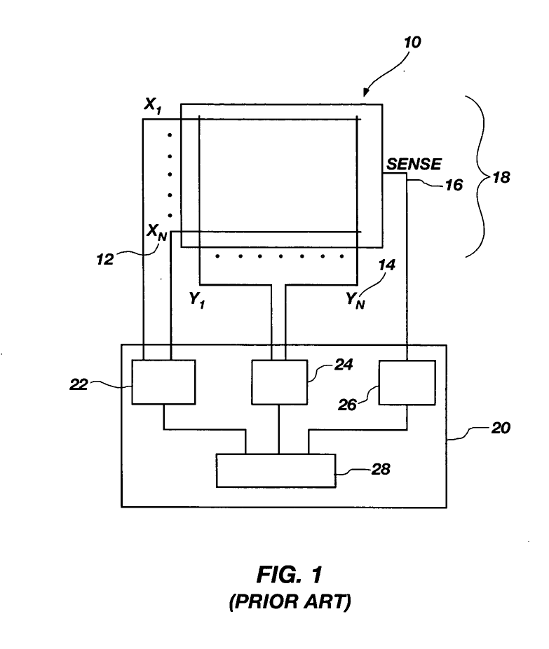

### DETAILED DESCRIPTION OF THE INVENTION

Reference will now be made to the drawings in which the various elements of the present invention will be given numerical designations and in which the invention will be discussed so as to enable one skilled in the art to make and use the invention. It is to be understood that the following description is only exemplary of the principles of the present invention, and should not be viewed as narrowing the claims which follow.

The presently preferred embodiment of the invention is essentially a capacitance-sensitive touchpad that is capable of performing proximity sensing of a fluid or fluids. Accordingly, a more accurate description is to state that the invention utilizes a capacitance-sensitive proximity sensing device that is disposed in a position relative to the container so that the device is capable of determining at least one characteristic of a fluid or fluids disposed within the container.

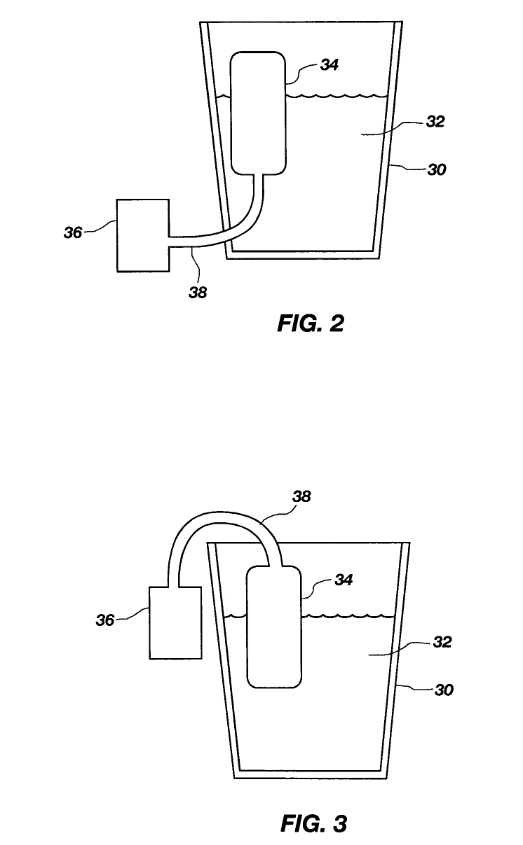

FIG. 2 is provided to show a container 30 and a fluid 32 within the container. A sensor array 34 is disposed outside the container 30, and flush against the container wall. In this configuration, the container 30 must either not interfere with the sensing technology of the invention, or provide an aperture or window into the container that will enable the sensor array 34 to operate. The touchpad sensor circuitry 36 is shown coupled to the sensor array 34 via ribbon cable or length of flexible substrate material 38.

It is noted that information from the touchpad sensor circuitry 36 can be transmitted to a computer or other receiving device via wired or wireless means, as known to those skilled in the art.

Because the proximity sensing device operates on well-established principles of mutual capacitance-sensitive touchpad technology, as described in patents issued and pending of CIRQUE® Corporation, it is observed that the container 30 must be comprised of a non-metallic material in order to not interfere with the capacitance-sensitive proximity sensing device if the sensor array 34 is sensing through a wall of the container. In other words, any material that would interfere with the operation of a capacitance sensitive touchpad cannot be used for the container 30, unless a non-interfering aperture is provided. However, a sensing aperture through which the sensor array 34 might operate can be comprised of a material that is different from the rest of the container 30.

The nature of the invention is such that the container 30 storing the at least one fluid 32 can have a curved surface for attachment of the sensor array 34. This is because the capacitance-sensitive proximity sensing technology of the sensor array 34 is capable of being disposed on a flexible substrate such as MYLAR™. The use of MYLAR™ for the substrate material enables the sensor array 34 to conform to slight surface contours that might be found in the shape of the container 30. For example, a generally cylindrical glass container such as a bottle provides an arcuate or curved surface that is suitable for the attachment of the sensor array 34. Likewise, a cylindrical underground storage tank for petrochemicals such as gasoline will also provide a suitable surface.

There are some useful observations that can be made regarding the container 30 through which the sensor array 34 can detect and/or examine a fluid 32 within. For example, the container 30 can have a variety of curved surfaces that can be used as a location for attachment of the sensor array 34. When sensing directly through the walls of a container 30, the materials used in the manufacture of the container are also many, and include glasses and plastics. This also means that while the sensor array 34 requires attachment to a non-metallic material in order to perform sensing of the at least one fluid 32 on the opposite side, the sensor array 34 could be disposed, for example, against a glass aperture that has been made part of a container wall, wherein the remainder of the container 30 can be constructed of metal or other materials that will otherwise interfere with the sensor array 34. However, it is also important that the thickness of the material through which the capacitance-sensitive proximity sensing device must operate should not be made so thick as to interfere with fluid detection and/or examination. The closer the sensor array 34 of the capacitance-sensitive proximity sensing device is disposed to the at least one fluid 32, the more accurate and perhaps the more detailed the information that can be obtained will be.

The nature of the capacitance-sensitive proximity sensing device that includes the sensor array 34 described above utilizes mutual capacitance technology to detect and derive information about the at least one fluid 32 in the container 30. Mutual capacitance sensor technology is described, for example, in U.S. Pat. No. 5,305,017 issued to CIRQUE® Corporation. However, the capacitance-sensitive proximity sensing device of the invention also utilizes hidden touch surface HTS™ technology as described in issued U.S. Pat. No. 6,680,731 B2. This technology enables proximity sensing. In other words, it is not necessary for the at least one fluid 32 to be in physical contact with the sensor array 34 of the capacitance-sensitive proximity sensing device. The at least one fluid 32 must only be sufficiently close so as to be within a range of detection and/or examination of the present invention. Thus, the sensor array 34 may be disposed on the outside of a container 30 as long as the container wall is of a thickness and material that enable proximity sensing.

The electrodes of the sensor array 34 of the present invention are preferably comprised of a conductive ink that is “printed” onto MYLAR™ sheets and is described in the '731 patent. This method of fabrication is very simple and inexpensive. However, more conventional fabrication techniques that are used to manufacture conventional touch-sensitive touchpads such as those found in computer input devices can also be used.

So far, the specification has described a sensor array 34 of a capacitance-sensitive proximity sensing device that functions when disposed along the outside of a container 30. Another aspect of the invention is to dispose the capacitance-sensitive proximity sensing device inside the container 30 itself. This process may be as simple as coupling the capacitance-sensitive proximity sensing device to an inside surface of the container 30, and providing a means for signals to travel from the sensor array 34 to the touchpad control circuitry 36.

If the fluid within the container 30 will not harm the sensor array 34, the sensor array may be disposed so as to enter the fluid 32. This is illustrated in FIG. 3. FIG. 3 shows the container 30, the fluid 32 within the container, the sensor array 34 at least partially disposed within the fluid, and touchpad sensor circuitry 36 coupled to the sensor array.

It is observed that given the fact that the invention utilizes electricity to function, it will most likely be necessary to cover and insulate all electrical circuitry and exposed elements and electrodes of the sensor array 34 the capacitance-sensitive proximity sensing device from the fluid 32 in the container 30. It may also be necessary to protect the sensor array 34 from the corrosive and otherwise deleterious effects of the fluid 32 in the container 30. Materials used to cover the all the elements of the capacitance-sensitive proximity sensing device are well known to those skilled in the art of insulating electronic components from fluids when working in wet and corrosive environments.

Having described the invention in general terms, it is useful to examine some experimental results that demonstrate the capabilities of the invention. In this example, three fluids were poured into a container. No attempt was made to adjust the amount of each fluid disposed therein. The fluids were generally not miscible, and were comprised of tap water, automobile engine oil, and alcohol. The container was open to air.

The three fluids and air have different densities. Accordingly, the fluids separated into vertically distinct layers in the container. The lowest fluid in the container was water, then oil, and finally alcohol.

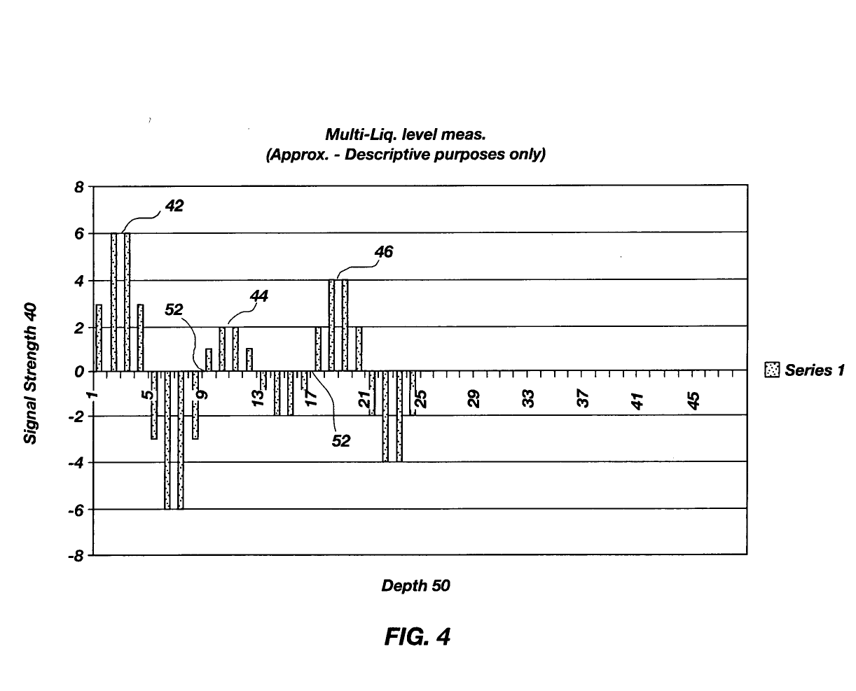

The fluids 32 have different dielectric and electrical properties, thereby causing each fluid to affect the conductive elements of the sensor array 34 in different and detectable ways. In this experiment, a normal touchpad from CIRQUE® Corporation that is used in computer input applications, and manufactured with a MYLAR™ substrate, was lowered directly into the fluid 32 in the container 30. The sensor array 34 was held in a vertically parallel orientation with respect to the upright sidewalls of the container 30. The sensor array 34 was coupled to touchpad sensor circuitry 36 also from CIRQUE® Corporation. The output of the electronic circuitry was then shown on a computer display as shown in FIG. 4.

The computer display is simply one means by which signal strength information can be recognized as indicating a difference in detectable characteristics of different fluids that were in proximity to the capacitance-sensitive proximity sensing device. The output that was shown on the computer display indicates signal strength. Signal strength 40 thus can also be used to detect the presence or absence of a fluid, as well as the composition of detected fluids.

The signal strength 40 is a function of the relative dielectric constants and other electrical properties of each fluid. The results indicated that water yielded the highest signal strength 42, followed by alcohol 46 and then oil 44. The surface air showed no substantial signal level as expected with the sensor array and touchpad sensor circuitry being used. It will most likely be necessary to test the sensing and examination capabilities of the present invention in order to understand fully what the present invention is capable of detecting.

The output also indicates the level or depth 50 of each fluid, relative to the sensor array 34. Thus, the invention indicates the boundary between each of the fluids as indicated by a zero-crossing 52 on the graph between the layers of each of the fluids. It is noted that depth in the x-axis is in arbitrary units, but in this case is approximately 0.5 mm. Likewise, the signal strength shown in the y-axis is also in arbitrary units. What was important is that the signal strengths of the various fluids can be compared in order to obtain the desired information.

It is noted that previous experiments have shown that electrically conductive fluids (e.g. salt water) produce a maximum signal level that is not dependent on the dielectric constant of the conducting fluid for those conductive elements on the sensor array that are disposed in the conducting fluid. However, the sensing method of the present invention can still be applied to determine the fluid levels because measurements between conductive elements that are not in the conducting fluid will appear as previously described.

It is envisioned that the invention can be applied to process management and control in a variety of industries, including oil pumping from wells, chemical processing and storage, and the storage of other materials which can be in solid, fluid or gaseous form. In other words, the present invention will also function with gases and solids, to varying degrees of success.

It is also envisioned that the present invention can be used to: 1) detect changes in electrical properties of surrounding media due to chemical reactions or changes in temperature, 2) detect the existence and magnitude of waves or other disturbances in each of the layers of fluid, 3) detect the addition or removal of any fluid by any means, 4) detect the degree of mixing and/or separation of different fluids, 5) detect differences in properties of the fluid in multiple locations within the container by use of multiple sensing elements or sensing elements whose geometry is designed for such purposes, and 6) detect the effects in two or three dimensions, depending upon the sensor's geometry and accompanying data processing capabilities.

Regarding separation of the sensor array from the fluid being detected and/or analyzed, separation of as much as 0.3 inches has been demonstrated. The present invention is probably capable of even greater separations. Successful detection may also depend upon the electrical properties such as the dielectric constant of the fluid being measured. Thus, the sensor array can be coated with a variety of non-conducting materials or be separated from the container by a variety of non-conducting materials. Furthermore, orientation and geometry of the sensor array with respect to the fluid being detected and/or analyzed can greatly influence functionality of the present invention.

Other aspects of the present invention that should be mentioned are the ability to respond rapidly to changes over time, the ability to make continuous measurements as opposed to discrete, one-time measurements, and the fact that direct contact between the sensor and the fluid, solid, or gas is not required.

It is to be understood that the above-described arrangements are only illustrative of the application of the principles of the present invention. Numerous modifications and alternative arrangements may be devised by those skilled in the art without departing from the spirit and scope of the present invention. The appended claims are intended to cover such modifications and arrangements.

What is claimed is:

1. A system for performing fluid level determination of at least one fluid, said system comprising:
a sensor array formed from a substrate and a plurality of conductive elements disposed thereon that create an array of sensor electrodes, wherein the sensor array includes at least one sensing surface;
touchpad sensor circuitry coupled to the sensor array for receiving signals from the sensor array that are indicative of electrical properties of the at least one fluid;
the at least one fluid disposed adjacent to the sensor array and which is in a proximity sensing range thereof; and
wherein the touchpad sensor circuitry provides data regarding a level of the at least one fluid relative to the at least one sensing surface of the sensor array.

2. The system as defined in claim 1 wherein the substrate is further comprised of a flexible substrate material that is capable of conforming to arcuate surfaces.

3. The system as defined in claim 2 wherein the at least one sensing surface conforms to a surface against which the flexible substrate material is disposed.

4. The system as defined in claim 1 wherein the system is further comprised of a container within which the at least one fluid is disposed.

5. The system as defined in claim 4 wherein the sensor array is disposed within the container.

6. The system as defined in claim 5 wherein the sensor array is coated in a protective material if the at least one fluid within the container can damage materials used in the sensor array.

7. The system as defined in claim 4 wherein the sensor array is disposed outside the container.

8. The system as defined in claim 7 wherein the sensor array is disposed flush against an outer wall of the container to thereby maximize exposure of the at least one sensing surface to the at least one fluid within the container.

9. The system as defined in claim 1 wherein the means for determining characteristics of the at least one fluid further comprises means for determining characteristics of the at least one fluid that can be derived from capacitance-sensing technology of the system.

10. The system as defined in claim 1 wherein the system further comprises means for determining a presence or absence of the at least one fluid within proximity sensing range of the system.

11. The system as defined in claim 1 wherein the system further comprises means for determining composition of the least one fluid within proximity sensing range of the system.

12. The system as defined in claim 1 wherein the system further comprises means for determining a fluid level of a plurality of fluids having different characteristics as detected by the capacitance sensing technology of the system.

13. A method for performing fluid level determination of at least one fluid, said method comprising the steps of:
(1) providing a sensor array having at least one sensing surface formed from a substrate and a plurality of conductive elements disposed thereon that create an array of sensor electrodes, touchpad sensor circuitry coupled to the sensor array for receiving signals from the sensor array, and wherein the touchpad sensor circuitry provides data regarding at least one fluid relative to the at least one sensing surface; and
(2) determining a fluid level of the at least one fluid using the sensor array and the touchpad sensor circuitry.

14. The method as defined in claim 13 wherein the method further comprises the step of providing a flexible substrate material that is capable of conforming to arcuate surfaces.

15. The method as defined in claim 14 wherein the method further comprises the step of conforming the at least one sensing surface to a surface against which the flexible substrate material is disposed.

16. The method as defined in claim 13 wherein the method further comprises the step of providing a container within which the at least one fluid is disposed.

17. The method as defined in claim 16 wherein the method further comprises the step of disposing the sensor array within the container.

18. The method as defined in claim 17 wherein the method further comprises the step of coating the sensor array in a protective material if the at least one fluid within the container can damage materials used in the sensor array.

19. The method as defined in claim 16 wherein the method further comprises the step of disposing the sensor array outside the container on a container wall.

20. The method as defined in claim 19 wherein the method further comprises the step of disposing the sensor array flush against the container wall to thereby maximize exposure of the at least one sensing surface to the at least one fluid within the container.

21. The method as defined in claim 13 wherein the method further comprises the step of determining characteristics of the at least one fluid that can be derived from capacitance-sensing technology of the system.

22. The method as defined in claim 13 wherein the method further comprises the step of determining a presence or absence of the at least one fluid within proximity sensing range of the system.

23. The method as defined in claim 13 wherein the method further comprises the step of determining composition of the least one fluid within proximity sensing range of the system.

24. The method as defined in claim 13 wherein the method further comprises the step of determining a fluid level of a plurality of fluids having different characteristics as detected by the capacitance sensing technology of the system.

25. The method as defined in claim 13 wherein the method further comprises the step of analyzing signal strength to determine characteristics of the at least one fluid.
